(19) United States
(12) Patent Application Publication
(10) Pub. No.: US 2009/0273462 A1
(43) Pub. Date: Nov. 5, 2009

(54) USING FIXED MOBILE CONVERGENCE FEMTOCELLS FOR ALARM REPORTING

(75) Inventor: Kenneth L. Addy, Massapequa, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/113,727

(22) Filed: May 1, 2008

(51) Int. Cl. G08B 23/00

(52) U.S. Cl. 340/506

(57) ABSTRACT

An alarm reporting system and method for reporting alarms to a central monitoring station via low-power femtocells is presented. An alarm reporting system comprises a plurality of sensors, an alarm reporting module that receives alarm signals from the plurality of sensors, and a logic unit that generates an alarm message related to the alarm signal. The alarm reporting module further comprises a low-power cellular transceiver to transmit the alarm message to the femtocell. The femtocell is connected to a fixed network such as the internet.

### FIELD OF THE INVENTION

The present invention relates to alarm reporting systems. Specifically, the present invention relates to using low-powered femtocells for communicating with a central monitoring station.

### BACKGROUND

Alarms are more in use today than ever before. Improvements in communication technology make it easier to install an alarm that reports events to a central monitoring station in real-time. In particular, network technology allows alarm-reporting equipment to report events using a ubiquitous packet-based network such as the Internet. Further, with the advent of cellular technology, alarms may be reported to a central monitoring station via a standard cellular network such as a 3G network.

Given the increasing sophistication of alarm reporting equipment and communications technology, it comes as no surprise that more information is being reported via such alarm reporting systems. For instance, not only does an alarm reporting system report the occurrence of an event, it also provides regular status updates. Further, multiple sensors may provide multiple status updates to an alarm control panel, which transmits this data constantly to a central monitoring station.

Incorporating a cellular transceiver in the alarm reporting system adds the requirement of a separate power source to ensure adequate coverage. Further, to comply with safety requirements, the cellular transceiver also requires an uninterruptible power supply (UPS) or a back-up battery, so that alarm reporting capability remains functional during a power outage.

Standard cellular transceivers are not very energy-efficient. Cellular phones typically have two types of battery life: talk-time, and standby. Talk times are usually quite short because of the power required to communicate with standard cellular base stations that are usually a few miles away from the phone/transceiver. Given the larger volumes of data being constantly transferred from an alarm reporting module to a central monitoring station, cellular transceivers have large power overheads. This leads to increased costs, both for the power supply unit (PSU) and the battery. More importantly, monitoring of the power supply for the transceiver and maintaining a robust battery charge to comply with safety requirements becomes an arduous and expensive task, increasing costs and risks for both alarm equipment installers and their clients.

Accordingly, there exists a need to take advantage of the increased throughput between alarm reporting modules and central monitoring stations, while conserving power usage to comply with safety standards.

### SUMMARY OF THE INVENTION

The present invention uses femto-cellular connectivity so that the transmitter power is reduced. This allows power to be supplied by lower power devices, or alternatively, from the alarm panel itself, without the need for an additional battery or PSU and related monitoring circuitry.

A femtocell is a miniature cellular base station that can be installed in a home, office, or any building. Femtocells have limited coverage areas compared to standard macrocell base stations, and consequently a cellular transceiver uses significantly less power to communicate with a femtocell. Femtocells provide connectivity to the core cellular network via a broadband Internet connection maintained by a third party.

The present invention is directed to an alarm reporting module coupled with a transceiver, wherein the transceiver is capable of communication with a femtocell. The femtocell is further capable of communication with a central monitoring station. This communication may occur over a broadband connection.

In one embodiment, an alarm reporting system comprises an alarm reporting module and a femtocell for receiving data from the alarm reporting module. A transceiver is coupled to the alarm reporting module, and shares the same power source and battery as the alarm reporting module. The femtocell may be a Home Base Station (HBS) incorporating a picocell that has the functions of a base station controller (BSC) as well as a mobile switching center (MSC).

In another embodiment, a sensor transmits an alert signal to an alarm reporting module. The sensor may be a smoke/fire detector, motion sensor, or any security sensor known in the art. The alert signal may be triggered by the occurrence of an event, such as a fire, opening of a door or window, etc. Alternatively, the alert signal may simply be a regularly transmitted status update. The alarm reporting module comprises a control panel that includes multiple zones corresponding to the type of event that triggered the alert signal. A logic unit within the control panel correlates the alarm signal to the corresponding event, and generates an alert message to be transmitted to a central monitoring station. The alarm reporting module further comprises a transceiver device capable of communicating with a femtocell. The transceiver device transmits the alert message to the femtocell via radio signals such as GSM/GPRS, EDGE, CDMA, or any current or future equivalent packet radio channels. The femtocell communicates with a fixed network such as the internet. The femtocell transmits the alert message to a central monitoring station that is also connected to the internet. Thus, the femtocell allows the cellular transceiver in the alarm reporting module to communicate via a fixed network.

In one embodiment, the femtocell is connected to a broadband internet connection via a separate modem and/or a router connected to the internet. In another embodiment, the femtocell comprises both the home base station and the modem/router connected to the internet.

In another embodiment, the present invention is a method for sending an alarm message from an alarm reporting module to a Central Monitoring Station on a fixed network, the method comprising the steps of receiving, at an alarm reporting module, an alert signal corresponding to an event, generating an alarm message corresponding to the alert signal, transmitting the alarm message using a cellular transceiver within the alarm reporting module to a femtocell, wherein the femtocell transmits the alarm message to the Central Monitoring Station across a fixed network such as the Internet.

### BRIEF DESCRIPTION OF THE DRAWINGS

FIG. 1 shows an alarm reporting module and a femtocell, according to an exemplary embodiment of the present invention.

FIG. 2 shows an alarm reporting system within a secure area, according to an exemplary embodiment of the present invention.

FIG. 3 shows multiple sensors communicating with multiple alarm reporting modules in multiple secure areas, according to an exemplary embodiment of the present invention.

### DETAILED DESCRIPTION

The present invention discloses an alarm reporting module coupled with a transceiver, wherein the transceiver is capable of communication with a femtocell. The femtocell acts as a miniature cellular base station that can be installed in a home, office, or any building, and provides connectivity to the core cellular network or other fixed networks. The femto-cell is further capable of communication with a central monitoring station. The transceiver and the alarm reporting module share the same power source and battery, thereby reducing power usage and expenses related to maintaining a standard cellular transceiver that has to communicate with a macrocell base station.

For the purposes of the present invention, a cellular transceiver, or simply a transceiver, is a device containing both a transmitter and a receiver. For instance, on a mobile telephone, the entire unit is a transceiver. A transceiver device within an alarm reporting module comprises a transmitter and a receiver capable of radio communication with a cellular macrocell base station, or a femtocell.

A macrocell base station is a standard cellular base station employed by cellular network operators. These usually comprise a base station controller, an antenna, and a radio network controller, wherein the radio network controller carries out radio resource management and connects to the core network.

A femtocell is a low-powered base station that resides within a building and provides a cellular transceiver with access to a fixed network. A femtocell typically comprises base station functionality, as well as means to communicate with a fixed network such as the internet. To access the internet, a femtocell may be connected to a broadband modem, or may simply incorporate within the femtocell an Ethernet or equivalent port to communicate with a fixed network.

A fixed network is any network system that is accessible via physical connections installed in a structure. For instance, the internet is a fixed network because at some point, there is a physical connection to the network of an internet service provider's network. Thus, fixed networks can include ISP networks, telecommunication operator's core networks, local area networks (LAN), wide area networks (WAN), and equivalents. A fixed network can further comprise a mobile network having fixed elements, however, the difference between a fixed and a mobile network is that a mobile unit can traverse multiple base stations that keep handing off the unit to each other. At some point in the base station, a radio network controller communicates with a gateway such as a GGSN or GMSC to communicate with fixed networks such as an IMS/IP network, or a PSTN network, respectively. Thus, in an embodiment of the present invention, a femtocell provides a cellular transceiver-equipped alarm reporting module with access to a fixed network such as the internet.

### Embodiments

The present invention will now be described with references to the figures.

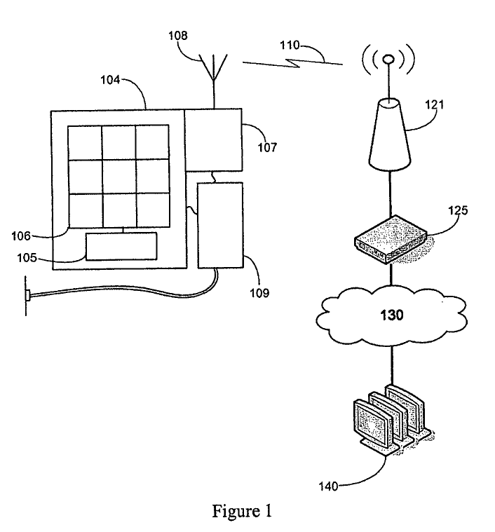

FIG. 1 shows an alarm reporting module and a femtocell, according to an exemplary embodiment of the present invention. Alarm reporting module 104 has a logic unit 105, a user interface 106, and is coupled to a cellular transceiver 107 having an antenna 108, and a power supply unit (PSU) 109. Cellular transceiver 107 is in radio communication 110 with femtocell 121. Femtocell 121 is optionally in communication with broadband modem 125, which provides access to fixed network 130. Central monitoring station 140 is also in communication with fixed network 130.

According to an embodiment of the invention, alarm reporting module 105 generates an alert message that is to be sent to central monitoring station 140. Generation of the alert message may be triggered upon receipt by alarm reporting module 105 of an alarm signal transmitted by a sensor (not shown). For instance, a sensor such as a carbon monoxide (CO) detector detects a dangerous level of CO and signals this to alarm reporting module 105. Logic unit 105 within alarm reporting module 104 correlates the incoming signal to the sensor and therefore to the event, and generates an alarm message to be transmitted to central monitoring station 140. Alternatively, the alarm message may be generated by logic unit 105 periodically to indicate a status or change of status within alarm reporting module 104. For instance, upon leaving a building, a user may activate a door alarm sensor via user interface 106. The user may do this by typing in a code on a keypad or touch screen to activate the alarm. Other means for activating the alarm are known in the art. This activation generates an alert message to be transmitted to central monitoring station 140, so central monitoring station 140 may do whatever it needs to do in response. In one embodiment, the alarm message may further comprise event-related data recorded by the sensor. For instance, a motion-sensing camera may transmit an alarm signal to alarm reporting module 104, wherein alarm reporting module 104 also includes video footage from the camera in the alarm message to be sent to central monitoring station 140. Similarly, other multimedia information can be transmitted as part of the alert message.

Power supply unit 109 powers both alarm reporting module 104 and transceiver 107. Power supply unit 109 may further comprise a backup battery, thus becoming an Uninterruptible Power Supply (UPS). Transceiver 107 uses very little power and thus can “piggyback” off power supply unit 109 without draining too much power.

Transceiver 107 is used to transmit the alert message to femtocell 121. Transceiver 107 is a cellular transceiver known in the art. It can communicate with existing base stations, as well as femtocells. Communication with femtocells uses significantly lower power overhead than that needed to communicate with macrocell base stations. Transceiver 107 transmits the alert message via radio waves 110. Radio waves 110 comprise any current or future cellular technology such as GPRS, CDMA, and equivalents. The power overhead is reduced because femtocell 121 is an extremely low-power base station unlike standard macrocell base stations. Thus, transceiver 107 can efficiently transmit data packets constantly to femtocell 121 without interruption, even during a power outage, for amounts of time exceeding safety standards.

Femtocell 121 is a low-power access point providing a pathway for cellular devices to connect to a fixed network 130. Femtocells are known in the art, and typically comprise elements of macrocell base stations such as base station controllers (BSC) as well as radio network controller (RNC) within a small portable unit. Femtocells provide high-speed mobile data inside buildings, at a significantly lower cost to operators because traffic is backhauled to the core network over the building's existing broadband link.

In one exemplary embodiment, femtocell 121 is in communication with network 130 via broadband modem 125. Broadband modem 125 could be any gateway or portal to a fixed network that is known in the art. For instance, a cable modem could be used providing access to the internet via a cable network. Any equivalent third-party provider internet connection can be used by femtocell 121. In another embodiment, femtocell 121 incorporates within itself similar means to access an internet connection. Thus, an external broadband router is not needed. In another embodiment, femtocell 121 and broadband modem 125 are both connected to UPS systems to provide a secure and failsafe alarm reporting system.

The alarm message then traverses network 130 to reach destination central monitoring station 140. Central monitoring station 140 is known in the art, and may comprise a plurality of computer servers that correlate and analyze incoming messages from a plurality of alarm reporting modules in different locations. Central monitoring station 140 may further be part of a broader central monitoring network that is in communication with several first responders, such as police, fire, and emergency care units. Thus, if the alarm message is one of great urgency, central monitoring station 140 ensures that, upon receipt of the message, appropriate action is taken. Central monitoring station 140 is connected to network 130.

According to an embodiment of the present invention, a sensor communicates with an alarm reporting module as described above. The sensor may be any security sensor known in the art such as a sensor to detect changes in the surrounding environment. This could be a motion detector, or a smoke, heat, or CO sensor. The objective of the sensor is to detect changes in the environment within a certain building or area defined as a secure area. Upon a change in an environmental condition, the sensor may transmit an alert message to the alarm reporting module. The alarm reporting module may also be housed within the secure area. Alternatively, a plurality of sensors could monitor conditions in a plurality of areas, and report back to the alarm reporting module in a separate room of the building. In this configuration, all areas covered by the alarm system can be referred to collectively as “the secure area.”

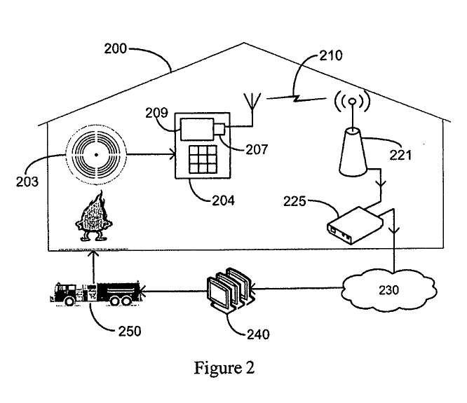

A secure area may also have a femtocell to provide connectivity to the alarm reporting module covering the secure area. In such a configuration, the femtocell accesses a broadband connection linked to the secure area, and provides access to a fixed connection for the alarm reporting module covering the area. FIG. 2 shows such a configuration, according to an exemplary embodiment of the present invention.

In FIG. 2, secure area 200 may be a home or office, or any structure that houses a security system. The security system includes a sensor 203 that is in communication with an alarm reporting module/control panel 204. In the present example, sensor 203 is a heat sensor, but any type of sensor can be used. Communication between sensor 203 and alarm reporting module 204 can be wired or wireless. Sensor 203 may communicate with alarm reporting module 204 via an Ethernet connection, wi-fi, or any equivalent means that allows an alarm signal and related data to be communicated. The alarm signal may be triggered by an event, such as a change in the environment around the sensor, or it may be a regular status update, low battery indicator, and so on.

An example will be described in which a fire has broken out in secure area 200. Since sensor 203 is a heat sensor, the fire triggers the generation of an alarm signal. The Sensor 203 transmits the alarm signal via wireless or wired link to alarm reporting module 205. Alarm reporting module 204 comprises a power supply unit 209 and a cellular transceiver 207. Both alarm reporting module 205 and transceiver 207 are powered by power supply unit 109, which may further comprise a battery, thus becoming a UPS. Cellular transceiver 207 communicates with a femtocell 221 via communication channel 210. Communication channel 210 is wireless and may be a GPRS, CDMA, or equivalent radio channel. Since femtocell 221 is a low-powered cellular base station, transceiver 207 in alarm reporting module 204 uses very little power to maintain communication with femtocell 221. This communication includes regular status updates as well as alarm messages. Consequently, an alarm message generated by alarm reporting module 204 is transmitted by the transceiver to femtocell 221.

Femtocell 221 is in communication with broadband modem 225. Broadband modem 225 is a link to a fixed network such as the internet 230. For instance, broadband modem 225 could be a DSL or cable modem having an Ethernet jack, and femtocell 221 communicates with broadband modem 225 via an Ethernet cable. Alternatively, both femtocell 221 and broadband modem 225 could be capable of wi-fi communication. Other methods of linking the two that are known in the art can also be used.

Thus, femtocell 221 transmits the alert message to a central monitoring station 240. The alert message traverses the internet 230 to arrive at one or more terminals within central monitoring station 240. Central monitoring station 240 is in constant communication with the internet, and terminals within central monitoring station 240 may be assigned an IP address that the alert message is destined for. Central monitoring station 240 may also have a unique Session Initiation Protocol (SIP) address, according to an exemplary embodiment. In this case, femtocell 221 or broadband modem 225 may also have unique SIP addresses, and fixed network 230 is an IP Multimedia System framework (IMS) or a hybrid IMS/IP network operated by a service provider.

In either case, alert message is delivered from femtocell 221 to central monitoring station 240, which then takes the appropriate action to remedy the situation. In the present embodiment, central monitoring station 240 recognizes the alert message as being a fire alert, and contacts fire station 250 to dispatch a truck to secure area 200. Alternatively, if the alert message is simply a status update, then central monitoring station 240 may store the event in a database or take other pre-programmed actions.

In an alternative embodiment, a plurality of sensors may be placed at various points within a structure, and may send alarm signals to an alarm reporting module. These various sensors together secure an area controlled by a single alarm reporting module. In yet another embodiment, there may exist a plurality of secure areas, each monitored by an alarm reporting module, within close range. For instance, a shopping mall or strip mall may have a plurality of stores in close proximity to each other. Each store has a plurality of sensors to detect various changes such as smoke, temperature, as well as motion sensors to prevent robberies. Each store further has an alarm reporting module/control panel that receives alarm signals from the sensors. The plurality of alarm reporting modules are further equipped with cellular transceivers to communicate alarm messages to a central monitoring station.

In such a situation, it may be convenient for the closely-spaced alarm reporting modules to access a single femtocell. The reasons for this are many; for instance, a femtocell having a specific cell size may receive interfering signals from a nearby transceiver. Reducing the cell size may provide insufficient coverage for modules within a store. The femtocell installer itself may choose to have a particular cell size per femtocell and install them in a way that multiple alarm reporting modules may access the same femtocell.

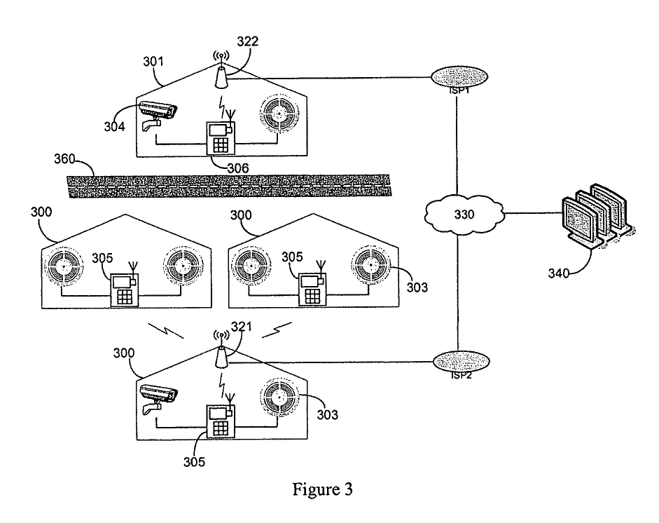

FIG. 3 shows a plurality of alarm reporting modules accessing a single femtocell, according to an exemplary embodiment of the present invention. Three secure areas 300 are within close range of femtocell 321. Each secure area 300 contains, inter alia, a plurality of sensors 303 and an alarm reporting module 305. In addition, one secure area 300 also houses femtocell 321. Across the street 360 is another secure area 301 having a plurality of sensors 304 and an alarm reporting module 306. Secure area 301 is out of range of femtocell 321 and thus uses its own femtocell 322.

Femtocell 305 communicates with an Internet Service Provider (ISP), in this case ISP1. This communication may occur via a broadband modem (not shown), or alternatively, femtocell 321 may have a built-in means for accessing a fixed network such as ISP1. Similarly, femtocell 322 accesses ISP2. Both ISP1 and ISP2 offer access to the same internet, which offers a means to connect to a central monitoring station 340 via IP, SIP, or equivalent means.

Sensors 303 may include smoke/heat/CO sensors, as well as motion sensors and CCTV cameras. Sensors 303 transmit alert signals to alarm reporting modules 305 wirelessly or using electrical/network cable. Alert signals may be triggered by events such as environmental changes, dying batteries, or may simply be regular status updates. Alarm reporting modules 305 generate alert messages depending on the type of alert signal, and use a cellular transceiver to communicate the alert messages to femtocell 322. Femtocell 322 can be tuned to encompass multiple alarm reporting modules, all of which have transceivers using low amounts of power. Thus each of alarm reporting modules 305 can provide power and backup power to their respective transceivers without adding separate batteries and power monitoring equipment to stay within safety requirements.

Secure area 301, on the other hand, works just like the embodiment described in FIG. 2, and need not be described in any more detail here.

While preferred embodiments of the present invention have been described using specific terms, such description is for illustrative purposes only, and it is to be understood that changes and variations may be made without departing from the spirit or scope of the following claims.

1) An alarm reporting system, comprising:
an alarm reporting module; and
a femtocell for receiving data from the alarm reporting module.

2) The alarm reporting system of claim 1, further comprising:
a transceiver coupled to the alarm reporting module for transmitting the data to the femtocell.

3) The alarm reporting system of claim 2, further comprising:
a power supply unit coupled to the alarm reporting module and to the transceiver to provide power to the alarm reporting module and to the transceiver.

4) The alarm reporting system of claim 1, further comprising:
a sensor for transmitting an alert signal; and
a transceiver within the alarm reporting module for receiving the alert signal from the sensor and transmitting an alert message to the femtocell;
wherein the alert message is said data.

5) The alarm reporting system of claim 4, wherein the alarm reporting module further comprises a logic unit to analyze the alert signal and correlate it to an event type.

6) The alarm reporting system of claim 1, wherein the femtocell is a Home Base Station providing a cellular transceiver with access to a fixed network such as the Internet.

7) The alarm reporting system of claim 6, wherein the Home Base Station further comprises a transceiver device and a Radio Network Controller.

8) The alarm reporting system of claim 6, wherein said transceiver is coupled to the alarm reporting module.

9) The alarm reporting system of claim 8, wherein communication between the transceiver coupled to the alarm reporting module and the femtocell occurs wirelessly via GSM, CDMA, or an equivalent public radio communication system.

10) The alarm reporting system of claim 9, wherein the transceiver device coupled to the alarm reporting module transmits an alert message to a Central Monitoring Station via the fixed network.

11) An alarm reporting system, comprising:
a sensor that transmits an alert signal corresponding to an event type;
a receiver that receives the alert signal;
a logic unit that generates an alert message corresponding to the alert signal;
a transmitter that transmits the alert message; and
a femtocell that receives the alert message and transmits the alert message to a Central Monitoring Station.

12) The alarm reporting system of claim 11, wherein communication between the transmitter within the alarm reporting module and the femtocell occurs wirelessly over one or more of GSM or CDMA channels.

13) The alarm reporting system of claim 11, wherein the femtocell communicates with the Central Monitoring Station via a broadband router connected to the Internet.

14) The alarm reporting system of claim 11, wherein the sensor transmits the alert signal wirelessly.

15) The alarm reporting system of claim 11, wherein the alert message corresponding to the alert signal corresponding to the event type includes all or part of the alert signal, wherein the alert signal comprises a multimedia stream recording the event that triggered the alert signal.

16) The alarm reporting system of claim 12, wherein the receiver, logic unit, and transmitter are contained within an alarm reporting module that farther includes a power supply unit that provides power to the alarm reporting module.

17) The alarm reporting system of claim 16, wherein the power supply unit further comprises a backup battery, thus becoming an Uninterruptible Power Supply (UPS).

18) A method for sending an alarm message from an alarm reporting module to a Central Monitoring Station on a fixed network, the method comprising:
receiving at an alarm reporting module an alert signal corresponding to an event;
generating an alarm message corresponding to the alert signal;
transmitting the alarm message using a cellular transceiver within the alarm reporting module to a femtocell; said femtocell being connected to the fixed network via a broadband internet connection; and
transmitting the alarm message using the femtocell to the Central Monitoring Station across the fixed network.

19) The method of claim 18, wherein the alarm reporting module and the cellular transceiver are powered by a power supply unit that further comprises a backup battery.
